(19) United States
(12) Patent Application Publication
(10) Pub. No.: US 2017/0097709 A1
(43) Pub. Date: Apr. 6, 2017

(54) TOUCH SENSITIVE DEVICE FIOR MOBILE APPARATUS

(71) Applicant: Vertu Corporation Limited, Church Crookham, Fleet, Hampshire (GB)

(72) Inventor: Karthik GURUCHANDRAN, Church Crookham, Fleet, Hampshire (GB)

(21) Appl. No.: 15/125,218

(22) PCT Filed: Mar. 10, 2014
(86) PCT No.: PCT/EP2014/054546

§ 371 Date: Sep. 12, 2016

(51) Int. Cl. G06F 3/041; G02F 1/1343; G02F 1/1335; G06F 3/044; G02F 1/1333

(52) U.S. Cl. CPC G06F 3/0412; G06F 3/044; G02F 1/133308; G02F 1/133528; G02F 1/13338; G02F 1/13439; G02F 1/134336; G06F 2203/04111; G02F 2001/133331; G02F 2201/122; G06F 2203/04103

(57) ABSTRACT

A touch sensitive device for a mobile apparatus, the device having a length in a direction of a first axis and a width in a direction of a second axis, wherein the length is greater than or equal to the width, the device comprising a substrate comprising sapphire with a first refractive index value, the sapphire comprising sapphire crystallographic structure having a plurality of crystal planes, wherein a first crystal plane axis is configured to be perpendicular to the first and the second axis; a first transparent electrode pattern layer with a second refractive index value configured to form a plurality of touch sensing elements parallel to the first axis; a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and an index matching layer arranged between the substrate and at least one the transparent electrode pattern layers configured to match the first refractive index value and at least one of the second refractive index value and the third refractive index value; wherein at least one of the transparent electrode pattern layers being integral to the substrate.

### TECHNICAL FIELD

The present invention relates generally to touch sensitive devices. The invention relates particularly, though not exclusively, to using a sapphire layer in the touch sensitive device of a mobile apparatus.

### BACKGROUND ART

Portable apparatuses, such as mobile phones, tablets and personal computers typically need user interface elements, such as displays and user input devices when constructing the product. Nowadays touch sensitive devices, such as touch screen or touch displays are very common. With increasing consumer awareness of quality and value mobile manufacturers are continuing to use more and more quality materials. With respect to mobile phones and tablets, the last couple of years have seen a market shift from use of plastic screens to more scratch resistant chemical toughened glass (for example Gorilla® Glass).

While Gorilla® Glass is a significant improvement over plastic it can still be scratched by everyday items such as keys or coins in bags and pockets. Also, the glass is easily fractured if the product is dropped. For this reason sapphire, for example, is being considered more and more for use on consumer goods. Sapphire is the second hardest naturally occurring material and can only be scratched by a small number of harder materials, such as diamonds. Sapphire is also a strong material and has a very high elastic modulus (stiffness). Thus, using sapphire in the construction of mobile apparatuses creates a very stiff product that is less likely to flex during accidental drop or impact. This makes sapphire a very resistant, long lasting material for mobile apparatus usage.

Sapphire is used as a protective cover material due to its higher hardness and strength compared to both plastic and glass, which prevents the screen being scratched or broken during daily use. At the same time, thickness of the mobile apparatus should be minimized.

Thus, especially for portable apparatuses an improved solution is needed to provide a touch sensitive device that reduces thickness of the apparatus and improves strength of it.

### SUMMARY

According to a first example aspect of the invention there is provided a touch sensitive device for a mobile apparatus, the device having a length in a direction of a first axis and a width in a direction of a second axis, wherein the length is greater than or equal to the width, the device comprising:
a substrate comprising sapphire with a first refractive index value, the sapphire comprising sapphire crystallographic structure having a plurality of crystal planes, wherein a first crystal plane axis is configured to be perpendicular to the first and the second axis;
a first transparent electrode pattern layer with a second refractive index value configured to form a plurality of touch sensing elements parallel to the first axis;
a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and
an index matching layer arranged between the substrate and at least one of the transparent electrode pattern layers configured to match the first refractive index value and at least one of the second refractive index value and the third refractive index value; wherein at least one of the transparent electrode pattern layers being integral to the substrate.

In an embodiment, the sapphire comprising sapphire crystallographic structure having a crystal plane, the crystal plane comprising at least one of the first and the second transparent electrode pattern layers.

In an embodiment, the first and the second transparent electrode pattern layers are isolated using an isolating layer.

In an embodiment, a portion of the second transparent electrode pattern layer comprising at least one jumper configured to cross over a portion of the first transparent electrode pattern layer.

In an embodiment, the jumper comprising indium tin oxide (ITO).

In an embodiment, at least one of the transparent electrode layer and the jumper comprising at least one of the following: indium tin oxide (ITO), graphene and silver nano wires.

In an embodiment, the second refractive index value and the third refractive index value are same.

In an embodiment, the second refractive index value and the third refractive index value are not same.

In an embodiment, the first transparent electrode layer comprising indium tin oxide (ITO) and the second transparent electrode layer comprising at least one of graphene and silver nano wires.

In an embodiment, the touch sensitive device further comprising a metal track layer arranged in an edge area of the touch sensitive device for the first and the second transparent electrode pattern layer, configured to provide connection for the first and the second transparent electrode pattern layers.

In an embodiment, the touch sensitive device further comprising a non-transparent mask layer arranged on the edge area of the touch sensitive device, wherein the non-transparent mask layer configured to hide the metal track.

In an embodiment, the metal track layer comprises a first and a second metal track.

In an embodiment, the touch sensitive device further comprises at least one of the following:
a display of the mobile apparatus;
a cover part of the mobile apparatus; and
a touch sensitive screen of the mobile apparatus.

In an embodiment, the device having a length in a direction of a first axis and a width in a direction of a second axis, wherein the length is greater than or equal to the width, the touch sensitive device further comprising:
sapphire crystallographic structure having a plurality of crystal planes, wherein a first crystal plane axis is configured to be perpendicular to the first and the second axis, a second crystal plane axis is configured to be parallel to the first axis and a third crystal plane axis is configured to be parallel to the second axis.

In an embodiment, the plurality of crystal planes comprising:
A-plane with A-axis configured to be a normal axis of the A-plane;
C-plane with C-axis configured to be a normal axis of the C-plane, the C-axis being perpendicular to the A-axis; and
M-plane with M-axis configured to be a normal axis of the M-plane, the M-axis being perpendicular to the A-axis and the C-axis.

In an embodiment, the first crystal plane axis is the A-axis, the second crystal plane axis is the M-axis and the third crystal plane axis is the C-axis.

In an embodiment, a fourth crystal plane axis is configured to be perpendicular to the first crystal plane axis and inclined to the second and the third crystal plane axes.

In an embodiment, the touch sensitive device having a length in a direction of the M-axis and a width in a direction of the C-axis, wherein the length is greater than or equal to the width.

In an embodiment, the plurality of crystal planes being arranged to match a liquid-crystal display (LCD) top polarizer angle of the display and configured to circularly or elliptically polarize outgoing light.

According to a second example aspect of the invention there is provided a method for providing a touch sensitive device for a mobile apparatus, the device having a length in a direction of a first axis and a width in a direction of a second axis, wherein the length is greater than or equal to the width, the method comprising:
providing a substrate comprising sapphire with a first refractive index value, the sapphire comprising sapphire crystallographic structure having a plurality of crystal planes, wherein a first crystal plane axis is configured to be perpendicular to the first and the second axis;
providing a first transparent electrode pattern layer with a second refractive index value configured to form a plurality of touch sensing elements parallel to the first axis;
providing a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and
providing an index matching layer arranged between the substrate and at least one the transparent electrode pattern layers configured to match the first refractive index value and at least one of the second refractive index value and the third refractive index value; wherein at least one of the transparent electrode pattern layers being integral to the substrate.

According to a third example aspect of the invention there is provided a mobile apparatus comprising a touch sensitive device of the first aspect.

In an embodiment, a higher strength axis of a sapphire element is aligned with a higher stress direction of the mobile apparatus.

The mobile apparatus may comprise a portable apparatus, such as a tablet, a smartphone, a mobile phone, a laptop, a digital camera or a personal digital assistant (PDA), for example.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows some details of a mobile apparatus in which various embodiments of the invention may be applied;

FIG. 2 shows some details of a mobile apparatus in which various embodiments of the invention may be applied;

FIG. 3 shows an illustrative example on a touch sensitive device in which various embodiments of the invention may be applied;

FIG. 4 presents a schematic view of a sapphire crystallographic structure for a touch sensitive device, in which various embodiments of the invention may be applied;

FIG. 5 presents a schematic view of a touch sensitive device, in which various embodiments of the invention may be applied;

FIG. 6 shows a flow diagram showing operations, in accordance with an example embodiment of the invention;

FIG. 7 presents an example block diagram of an apparatus in which various embodiments of the invention may be applied;

FIG. 8 shows a schematic view of a sapphire crystal structure, known also as a unit cell, having a plurality of crystal planes, in which various embodiments of the invention may be applied;

FIG. 9 shows an illustrative example on a touch sensitive device in which various embodiments of the invention may be applied; and

FIG. 10 shows an illustrative example on a portion of a touch sensitive device in which various embodiments of the invention may be applied.

### DETAILED DESCRIPTION

In the following description, like numbers denote like elements.

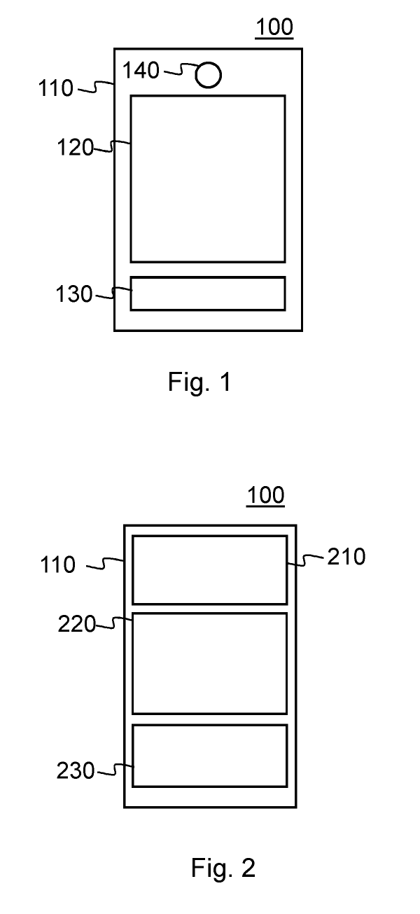

FIG. 1 shows some details of a mobile apparatus 100 in which various embodiments of the invention may be applied.

In an embodiment, the mobile apparatus 100 may comprise a mobile phone, a smart phone, a tablet, a laptop or any other portable apparatus. The apparatus comprises at least one cover part 110 for providing protection to the components of the apparatus 100 and creating desired outlook and outer design for the apparatus 100. The cover part 110 may comprise several separate cover parts, such as front and rear covers and even a side frame. In FIG. 1, mainly the front cover is shown. The apparatus 100 further comprises user interface 120, 130 comprising at least one display 120. The display 120 may be a touch-sensitive display for detecting user gestures and providing feedback for the apparatus 100. The apparatus 100 may also comprise a user input device 130, such as a keypad or a touchpad, for example. Furthermore, the apparatus 100 may comprise a camera 140. No matter the described elements 110, 120, 130, 140 are shown on the same side of the apparatus 100, they can be located on any side of the apparatus 100. No matter a plurality of apparatus elements 120-140 are illustrated in FIG. 1, they all need not to be included. For example, only a touch-sensitive display 120 may be included without the need for separate user input device 130.

In an embodiment, at least one of the apparatus elements 110, 120, 130 comprises a touch sensitive device, such as touch sensitive display, touch screen or touch sensitive cover part, for example. The cover part 110 may comprise a touch sensitive device to provide good-looking, strong and scratch resistant touch sensitive surface for the apparatus. The display 120 may comprise a touch sensitive device display, to provide strong and scratch-resistant touch display with minimum thickness. The user input device may comprise a touch sensitive device, such as a touchpad.

In an embodiment, the touch sensitive device, such as a touch sensitive display 120 may be an exchangeable component.

In an embodiment, the touch sensitive display 120 may form a permanent part of the cover part 110 or, to increase the potential for upgrading the engine throughout the life of the cover part 110 it may be a module that can be replaced too. Alternatively, a protective layer of the display 120 may be a part of the cover part 110 that layer may be independently exchanged. In further alternative embodiment the protective layer of the display 120 is integrated to the cover part 110.

In embodiments of the invention, the touch sensitive device may provide an operating face of the device. This gives a design engineer far greater freedom to design a device with a desirable appearance. The operating face may be provided with a user input element 130, for example a key, a touchpad, or an array of such elements. The casing may be a conventional one part casing or a clam shell, or other two or more part arrangement, where the user input elements 130 or keys may be located on a different face to a display 120.

In an embodiment, at least one of the apparatus elements 110-130 comprises a touch sensitive device, the device having a length in a direction of a first axis and a width in a direction of a second axis, wherein the length is greater than or equal to the width. Such device also comprises a substrate comprising sapphire, the sapphire comprising sapphire crystallographic structure having a plurality of crystal planes, wherein a first crystal plane axis is configured to be perpendicular to the first and the second axis. The touch sensitive device further comprises a first transparent electrode pattern layer with a second refractive index value configured to form a plurality of touch sensing elements parallel to the first axis; a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and an index matching layer arranged between the substrate and at least one of the transparent electrode pattern layers configured to match the first refractive index value and at least one of the second refractive index value and the third refractive index value; wherein at least one of the transparent electrode pattern layers being integral to the substrate.

In an embodiment, the second refractive index value and the third refractive index value are same values and the first transparent electrode pattern layer and the second transparent electrode pattern layer are of same material.

In an embodiment, the second refractive index value and the third refractive index value are not same values and the first transparent electrode pattern layer and the second transparent electrode pattern layer are of different material.

In an embodiment, a substrate may comprise clear ceramic instead of sapphire.

FIG. 2 shows some details of a mobile apparatus 100 in which various embodiments of the invention may be applied.

In an embodiment, the cover part 110 may also comprise a plurality of cover part elements, located in front and rear covers and in a side frame. In FIG. 2, mainly the rear cover of the apparatus 100 is shown. The apparatus 100 may comprise cover part elements comprising at least one touch sensitive device 210-230. Such touch sensitive devices 210-230 may be configured to provide not only user input, but also decorative effects, protective features for underlying elements, and operational features for the apparatus 100, such as speaker or microphone housings. The rear cover of the cover part 110 shown in FIG. 2 may also comprise touch sensitive devices 210-230, such as display or touchpad, for example. No matter the described elements 210-230 are shown on the same side of the apparatus 100, they can be located on any side of the apparatus 100. No matter a plurality of apparatus elements 210-230 are illustrated in FIG. 2, they all need not to be included.

In an embodiment, at least one of the apparatus elements 210-230 comprises a touch sensitive device, the device having a length in a direction of a first axis and a width in a direction of a second axis, wherein the length is greater than or equal to the width. Such device also comprises a substrate comprising sapphire, the sapphire comprising sapphire crystallographic structure having a plurality of crystal planes, wherein a first crystal plane axis is configured to be perpendicular to the first and the second axis. The touch sensitive device further comprises a first transparent electrode pattern layer with a second refractive index value configured to form a plurality of touch sensing elements parallel to the first axis; a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and an index matching layer arranged between the substrate and at least one the transparent electrode pattern layers configured to match the first refractive index value and at least one of the second refractive index value and the third refractive index value; wherein at least one of the transparent electrode pattern layers being integral to the substrate.

In an embodiment, a touch sensitive device comprises a first transparent electrode pattern layer with a second refractive index value configured to form a plurality of touch sensing elements parallel to the first axis and a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling. Furthermore, the touch sensitive device comprises an index matching layer arranged between the substrate and at least one of the transparent electrode pattern layers configured to match the first refractive index value and at least one of the second refractive index value and the third refractive index values; wherein at least one of the transparent electrode pattern layers being integral to the substrate.

The first transparent electrode pattern layer and the second transparent electrode pattern layer transparent electrode pattern layer may be of different materials. The first transparent electrode pattern layer may comprise indium tin oxide (ITO) and the second transparent electrode pattern layer (e.g. jumper) may comprise silver nano wires, for example. This means that the transparent electrode pattern layers have two different refractive indices.

Sapphire may be used for mobile apparatus touch sensitive devices, such as display, cover part element or touch pad, for example. Sapphire has high hardness and strength. Likewise, clear ceramic can also be used which has higher hardness and strength than glass.

The present invention discusses both sapphire and alumina. The chemical composition of both is based on Al₂O₃. For clarifying purposes, sapphire may be understood in this context as a single crystal of alumina and alumina as a polycrystalline form of alumina (PCA).

So far sapphire has been used only as a cover glass. Traditional approaches using optical lamination of sensors to display glass and using cover layer add thickness to the display assembly and thus also to the product, and also add costs due to additional lamination and yield drop due to multiple stage laminations & scratches in the display glass, for example.

To achieve better display window strength, an ion exchanged glass variant like gorilla glass may be used. Such glass is isotropic, however. This has a disadvantage that such design, when integrated with a polarizer based display solution, is not compatible with polarized sunglasses of the user. Most liquid-crystal displays (LCDs) typically have just a linear polarizer on the top surface generating linearly polarized light which is not polarized sunglass compatible. Polarizer based displays comprise, for example, a liquid-crystal display (LCD) that has a significant market share in handheld devices when compared to an emissive display solution, such as an organic light-emitting diode (OLED). To make such design compatible with polarized sunglasses, additional ¼ wave plates are laminated on to the display to circularly polarize the light from the display module. This means additional operations and elements to the liquid-crystal display (LCD) and also increases the device thickness, cost and potential yield drop due to additional lamination

Furthermore, touch sensor pattern visibility is a relevant quality and design issue, which directly impacts the user. The visibility on glass or acrylic substrate designs are greater due to the fact that the refractive index of such substrates are relatively lower than the refractive index of a transparent touch electrode used, such as indium tin oxide (ITO). This leads to vigorous index matching using multiple layers of coating a low refractive index material, such as SiO2 followed by coating a high refractive index materials, Ta2O5, for example. This approach increases cost and results in yield drop again.

Furthermore, it is desired that a solution is used that is not prone to scratches and has improved strength. The cost of the display touch assembly is remarkable compared to total costs, and touch sensitive display is also seen as one of the main input/output interface. Hence care needs to be taken to prolong the life of the display touch assembly, which also helps to differentiate the product from the rest of the competition.

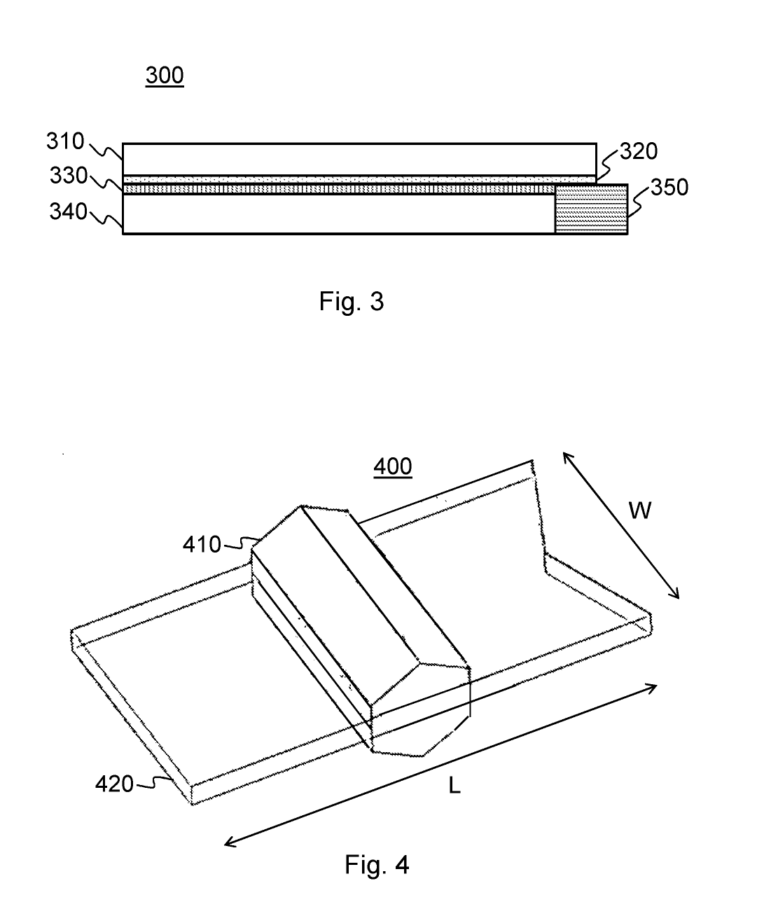

FIG. 3 shows an illustrative example on a touch sensitive device 300 in which various embodiments of the invention may be applied.

The invention enables designing and manufacturing touch sensors directly on to sapphire substrate.

A sapphire layer could be used as touch sensor substrate and construct the capacitive touch sensor directly on sapphire. A certain sapphire plane could be selected Such approach provides multiple benefits like very high scratch resistance and robustness when compared to glass, reduced product thickness, better yield and less complicated lamination process.

In an embodiment, the entire display touch solution is optimized for thickness, optical performance and reliability performance without compromising on any existing integration techniques used in the trade. Any type of display technology could be used and embodiments are not limited to displays only but any touch sensitive devices are included, such as touch screens, touchpads, and touch sensitive cover parts, for example.

In an embodiment, sapphire or ceramic substrate could be used as one touch sensor layer (say X electrode) and another material layer (film, glass, sapphire or clear ceramic) as the second touch sensor layer (say Y electrode). This could give the same benefits with potentially lower manufacturing costs, but with marginally increased thickness

In an embodiment, all of the touch sensing electrodes may be placed on to a thin material (film, glass, sapphire or clear ceramic) which will perform the touch function and then this material is laminated to a sapphire or ceramic cover glass.

In an embodiment, a touch sensitive device 300 for a mobile apparatus is provided. The device 300 comprises a substrate 310 comprising sapphire with a first refractive index value, the sapphire comprising sapphire crystallographic structure having a plurality of crystal planes. The substrate layer 310 comprises a touch sensor layer 320 comprising a first transparent electrode pattern layer with a second refractive index value configured to form a plurality of touch sensing elements and a second transparent electrode pattern layer with a third refractive index value configured to form a plurality of touch sensing elements. The first transparent electrode pattern layer and the second transparent electrode pattern layer of the touch sensor layer 320 are configured to provide touch information using capacitive coupling.

In an embodiment, the second transparent layer comprises jumpers when applied directly on to sapphire. In this case, the first layer has almost all of the X and Y lines and the second layer is used only to connect the missing connections to complete the matrix using the jumpers.

In an embodiment, an index matching layer is arranged between the substrate 310 and at least one the transparent electrode pattern layers of the touch sensor layer 320 configured to match the first and the second refractive index values; wherein at least one of the transparent electrode pattern layers of the touch sensor layer 320 is integral (e.g. sputtered) to the substrate 310.

In an embodiment, an optically clear adhesive layer 330 is used to attach at least one of the substrate 310 and the touch sensor layer 320 to a display 340. The display may comprise LCD or OLED display, for example. Furthermore, a flexible printed circuit 350 may be used for providing electrical connection for the touch sensor layer 320 or the display 340, or for both.

Sapphire may be used as the base material to deposit transparent conductive electrodes made of materials like indium tin oxide (ITO), graphene, silver nanowires etc. along with suitable index matching layers tuned to effectively hide the conductive electrodes becoming visible after etching a suitable capacitive touch pattern. Etching may be done using photolithography or using laser ablation but is not limited to these technologies. Insulators can be printed using inkjet technology, for example, or can be deposited and then etched so to form a basis to make cross over electrodes or jumpers for the touch sensor. The cross over electrode or jumper may also be constructed using materials like ITO, graphene, silver nanowires, etc. Metal tracks that are made of highly conductive materials like copper or silver, for example, will be connected to the transparent electrodes and then routed to bond to a printed circuit, such as flexible circuit board 350.

In an embodiment, the metal tracks do not run in both layers. The metal tracks may be arranged on the same plane as the first transparent layer and connect to both of the X and Y tracks in the same layer. The jumpers may be located on the second layer and the second layer may not comprise any metal tracks. However the metal tracks are on each layer in the case of film sensor optically laminated to sapphire.

In an embodiment, black mask ink with suitable optical density may be used to hide the metal tracks and their connection to the sensor electrodes both from the user side and the underside to make it easier to bond the sapphire touch part 320 to the display 340. The black mask ink may be applied in the inner surface of the sapphire and not on top. The metal tracks may be processed after black mask is applied, hence they are hidden from the users view. Another layer of black mask may be applied after metal tracks are etched to protect them and insulate them.

Sapphire is a single crystal material, i.e. it is grown as a continuous large single crystal without grain boundaries. Such a single crystal may be grown before cutting to a desired size and shape for a touch sensitive device.

The sapphire single crystal, i.e., Al₂O₃, is used because it has higher hardness and toughness than e.g. glass. The single crystal of sapphire may be pulled, growing a seed crystal in contact with the surface of the molten alumina to produce the single crystal into a larger single crystal, so as to generally work the single crystal into the desired shape.

FIG. 4 presents a schematic view 400 of a sapphire crystallographic structure 410 for a touch sensitive device 420, in which various embodiments of the invention may be applied.

The touch sensitive device 420 may be a display element, for example. The touch sensitive device 420 is developed by growing the sapphire crystallographic structure 410. The growing may be arranged in desired planes after detecting the planes and axes of the sapphire single crystal, for example.

In an embodiment, the desired dimensions of the touch sensitive device 420 comprise a length L over a first axis and a width W over a second axis, as shown in FIG. 4.

In an embodiment, orientation of the sapphire unit cell 410 may be selected so that the plane of the touch sensitive device 420, such as an optical element, corresponds to certain planes of the sapphire cell.

In an embodiment, the sapphire planes may be arranged to match a liquid-crystal display (LCD) top polarizer angle in such a way it retards one axis (called slow axis) more than the other thereby circularly or elliptically polarizing the outgoing light.

A touch sensitive device 420 may have a length (L) in a direction of a first axis and a width (W) in a direction of a second axis, wherein the length is greater than or equal to the width. The device comprises a substrate comprising sapphire with a first refractive index value, the sapphire comprising sapphire crystallographic structure having a plurality of crystal planes, wherein a first crystal plane axis is configured to be perpendicular to the first and the second axis.

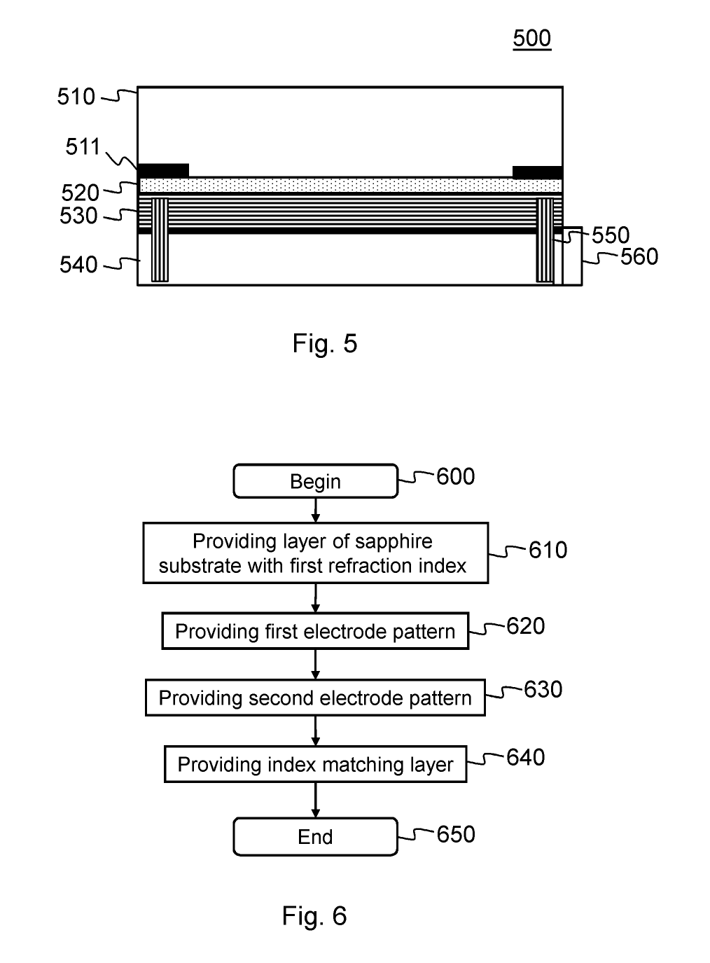

FIG. 5 presents a schematic view of a touch sensitive device 500, in which various embodiments of the invention may be applied. The touch sensitive device 500 may comprise a layer of sapphire 510 having a first refractive index value and comprising a surface, wherein the surface is visible to a user.

In an embodiment, a polished sapphire 510 with a desired minor plane orientation may be printed with a black mask layer 511. The black mask layer 511 may be provided on the edge areas of the touch sensitive device 500 to make metal tracks below invisible to the user. Choosing certain orientation of sapphire in terms of optical performance may enable avoiding additional ¼ wave plates required to circularly or elliptically polarize light to maintain polarized sunglass compatibility.

Index matching layer 520 is then applied. This layer 520 is to match the refractive indices of sapphire 510 with a transparent conductive electrode layer 530 which will form the X & Y layers. The sensor electrode pattern layer 530 might have both X and Y layers in the same plane and will be crossed over by indium tin oxide (ITO) jumpers or might have just one electrode in the sapphire surface, for example.

In an embodiment, both X & Y layers of the transparent conductive electrode layer 530 may be arranged on sapphire 510 surface. Then insulators may be applied either by spin coating or spray coating or another suitable process to form a uniform thickness and then photo-etched using a photo mask or ablated using laser or another similar process to form insulators for the indium tin oxide (ITO) jumpers.

Indium tin oxide (ITO) jumpers may be sputtered on top of these insulators and then etched using a suitable etching process like photolithography or laser ablation or similar and then connected to the corresponding sensor electrodes to complete the X & Y matrix that forms the basis of capacitive sensors.

In an embodiment, just one electrode (X or Y electrode) is arranged on sapphire 510 surface. Then insulators may not be used. Instead a separate material (film, glass or sapphire or clear ceramic) containing the other electrode will be optically bonded to the original sapphire substrate. The two electrodes will complete the X & Y matrix for capacitive sensing.

A display 540 is arranged below the transparent electrodes 530. If the display 540 is not optically laminated to the sapphire and touch layers 510-530, additional index matching layers (sometimes referred to back index matching) will be required on top of the display 540 to reduce reflections arising due to refractive index mismatch between sapphire (or indium tin oxide (ITO)) and the air gap used. In some cases, a back index matching may be used either way to optimize indium tin oxide (ITO) edge visibility, even when the display 540 is optically laminated to the sapphire touch component 510-530.

Metal tracks 550 may need to be routed and then connected to the electrodes 530. The metal tracks 550 are generally made of highly electrically conductive materials like copper, silver etc. and may be sputtered and then etched similar to the indium tin oxide (ITO) pattern etching process. The black mask 511 that was applied in the first step aims to hide these metal tracks 550.

Another layer of black mask may then applied to hide the metal tracks to be visible and also insulate them from any conductive material to avoid short circuits.

The metal tracks 550 may be routed in such a way that they come to a set of pads where a flexible printed circuit (FPC) 560 is bonded using suitable processes like anisotropic conductive film (ACF). The printed circuit 560 may carry the touch controller and other suitable components in it to make the touch sensor 530 or the apparatus functional. It also carries suitable connectors to connect to the main engine to interact with the other parts of the mobile apparatus.

The invention helps achieve a simpler display touch assembly that has all the benefits of a conventional display touch assembly but one which is much thinner. With a fine-tuned process we might be able to achieve very high yield with this invention because sapphire is not easy to scratch and there is no cutting process required. In conventional touch sensor on cover glass process, the main yield drop is due to scratches, cutting and reduced strength.

Yield needs to be very high for this process to compete with traditional display and touch assemblies or else this solution doesn't look competitive. One of the ideas to handle such situation is to use a hybrid touch on sapphire, where just one electrode is on main sapphire and the other electrode is on a separate layer made of different material (film, glass or sapphire or clear ceramic). This increases yield as the number of process steps on sapphire is significantly reduced and makes it cost effective. From pattern visibility point of view, this may be better as much simpler indium tin oxide (ITO) patterns can be tried and they need not have indium tin oxide (ITO) bridges which are required for non-hybrid touch on sapphire display and touch assemblies.

In an embodiment, reflections may be reduced using a textured structure on a surface of the sapphire 510. The textured features may reduce the reflection by either ‘trapping’ incident light within the structure 510 and or by creating a gradual change in the overall structure's refractive index. The structure can be applied to the screen as a surface coating or film or be an inherent part of the display screen. A textured structure created as part of the sapphire screen surface may be a permanent and robust solution for reducing the reflectance from a sapphire mobile apparatus screen.

In an embodiment, a first transparent electrode pattern layer with a second refractive index value is configured to form a plurality of touch sensing elements parallel to the first axis and a second transparent electrode pattern layer with a third refractive index value is configured to form a plurality of touch sensing elements parallel to the second axis, wherein the first transparent electrode pattern layer and the second transparent electrode pattern layer configured to provide touch information using capacitive coupling. The first transparent electrode pattern layer and the second transparent electrode pattern layer are comprised by the transparent conductive electrode layer 530.

In an embodiment, at least one of the first transparent electrode pattern layer and the second transparent electrode pattern layer may be integrated to another layer, such as to the sapphire element 510, for example.

In an embodiment, a first transparent electrode pattern layer and a second transparent electrode pattern layer may be separated with another layer, for example an index matching layer 520, in between them. Such embodiment could be illustrated by amending FIG. 5 so that the transparent conductive electrode layer 530 is divided to two layers and arranging another index matching layer 520 between the two transparent conductive electrode layers.

In an embodiment, a sapphire crystallographic structure has a crystal plane and the crystal plane comprises at least one of the first and the second transparent electrode pattern layers.

In an embodiment, the first and the second transparent electrode pattern layers are isolated using an isolating layer.

In an embodiment, a portion of the second transparent electrode pattern layer comprises at least one jumper configured to cross over a portion of the first transparent electrode pattern layer to form the second transparent electrode pattern layer. At least one of the transparent electrode pattern layers and the jumper comprise at least one of the following: indium tin oxide (ITO), graphene and silver nano wires.

FIG. 6 shows operations in a portable apparatus in accordance with an example embodiment of the invention.

In step 600, a method for providing a touch sensitive device for a mobile apparatus, the device having a length in a direction of a first axis and a width in a direction of a second axis, wherein the length is greater than or equal to the width, is started. In step 610, a substrate comprising sapphire with a first refractive index value is provided, the sapphire comprising sapphire crystallographic structure having a plurality of crystal planes, wherein a first crystal plane axis is configured to be perpendicular to the first and the second axis. In step 620, a first transparent electrode pattern layer with a second refractive index value is provided, configured to form a plurality of touch sensing elements parallel to the first axis. In step 630, a second transparent electrode pattern layer with a third refractive index value is provided, configured to form a plurality of touch sensing elements parallel to the second axis, wherein the first transparent electrode pattern layer and the second transparent electrode pattern layer are configured to provide touch information using capacitive coupling. In step 640, an index matching layer is provided between the substrate and at least one the transparent electrode pattern layers configured to match the first refractive index value and at least one of the second refractive index value and the third refractive index value; wherein at least one of the transparent electrode pattern layers being integral to the substrate. In step 650, the method ends.

In an embodiment, the order of the steps 610-650 may vary. Index matching layer may be first applied to sapphire substrate followed by indium tin oxide (ITO) sputtering and pattern etching and then Insulator coating and etching followed by second indium tin oxide (ITO) sputtering and etching and finally metal track sputtering and etching finishing with a back index matching later for reduced reflection.

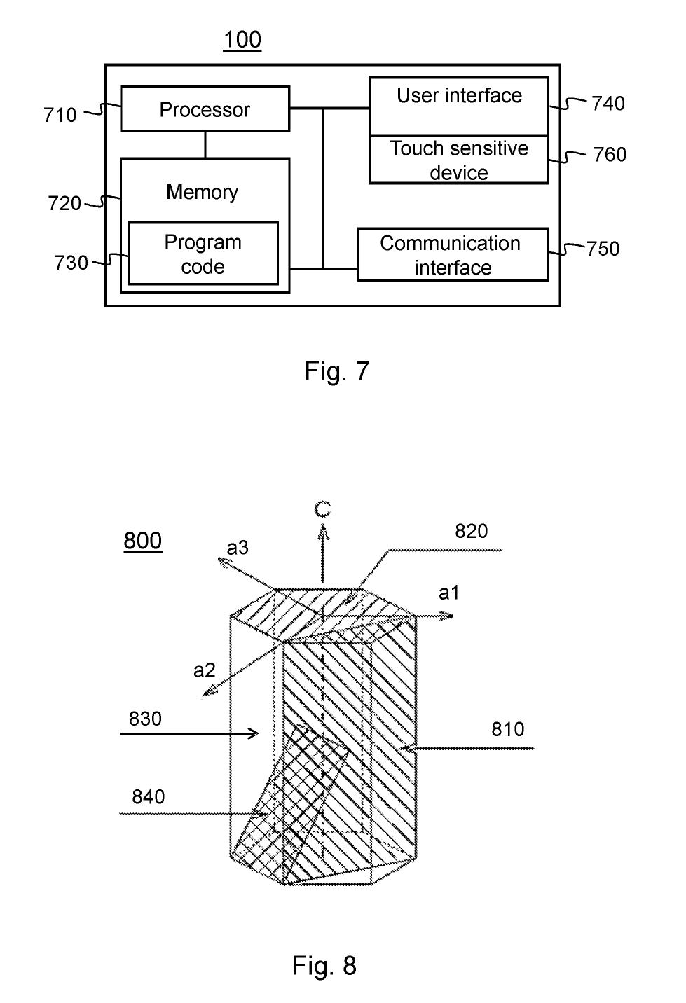

FIG. 7 presents an example block diagram of a portable apparatus 100 in which various embodiments of the invention may be applied. The portable apparatus 100 may be a user equipment (UE), user device or apparatus, such as a mobile terminal, a smart phone, a personal digital assistant (PDA), a MP3 player, a laptop, a tablet or other electronic device.

The general structure of the mobile apparatus 100 comprises a user interface 740, a communication interface 750, a processor 710, and a memory 720 coupled to the processor 710. The apparatus 100 further comprises software 730 stored in the memory 720 and operable to be loaded into and executed in the processor 710. The software 730 may comprise one or more software modules and can be in the form of a computer program product. The apparatus 100 further comprises a touch sensitive device 760, the device having a length in a direction of a first axis and a width in a direction of a second axis, wherein the length is greater than or equal to the width. The device 760 further comprises a substrate comprising sapphire with a first refractive index value, the sapphire comprising sapphire crystallographic structure having a plurality of crystal planes, wherein a first crystal plane axis is configured to be perpendicular to the first and the second axis. Furthermore, the device 760 may comprise a first transparent electrode pattern layer with a second refractive index value configured to form a plurality of touch sensing elements parallel to the first axis; a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and an index matching layer arranged between the substrate and at least one the transparent electrode pattern layers configured to match the first refractive index value and at least one of the second refractive index value and the third refractive index value; wherein at least one of the transparent electrode pattern layers being integral to the substrate.

The touch sensitive device 760 may also be integrated to another element of the apparatus 100, for example to the user interface 740.

The processor 710 may be, e.g. a central processing unit (CPU), a microprocessor, a digital signal processor (DSP), a graphics processing unit, or the like. FIG. 7 shows one processor 710, but the apparatus 100 may comprise a plurality of processors.

The memory 720 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 100 may comprise a plurality of memories.

The memory 720 may be constructed as a part of the apparatus 100 or it may be inserted into a slot, port, or the like of the apparatus 100 by a user. The memory 720 may serve the sole purpose of storing data, or it may be constructed as a part of an apparatus serving other purposes, such as processing data.

The user interface 740 may comprise circuitry for receiving input from a user of the apparatus 100, e.g., via a keyboard, graphical user interface shown on the display of the user apparatus 100, speech recognition circuitry, or an accessory device, such as a headset, and for providing output to the user via, e.g., a graphical user interface or a loudspeaker. The display of the user interface 740 may comprise a touch-sensitive display. The touch sensitive device 760 may be integrated to the user interface 740, such as a display, a keyboard, or a touchpad. The touch sensitive device may also be integrated to a cover part of the apparatus 100.

The touch sensitive device 760 may also provide a protective sheet for multiple elements of the apparatus 100. In an example embodiment, a touch sensitive device 760 is configured to provide a protective sheet for the display of the apparatus 100. The touch sensitive device may even cover at least a part of the front, rear or side surface of the apparatus 100 cover.

The communication interface module 750 implements at least part of radio transmission. The communication interface module 750 may comprise, e.g., a wireless interface module. The wireless interface may comprise such as near field communication (NFC), a WLAN, Bluetooth, infrared (IR), radio frequency identification (RF ID), GSM/GPRS, CDMA, WCDMA, or LTE (Long Term Evolution) radio module. The communication interface module 750 may be integrated into the user apparatus 100, or into an adapter, card or the like that may be inserted into a suitable slot or port of the apparatus 100. The communication interface module 750 may support one radio interface technology or a plurality of technologies. The apparatus 100 may comprise a plurality of communication interface modules 750.

A skilled person appreciates that in addition to the elements shown in FIG. 7, the apparatus 100 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 100 may comprise a disposable or rechargeable battery (not shown) for powering when external power if external power supply is not available.

FIG. 8 shows a schematic view of a sapphire crystal structure 800, known also as a unit cell, having a plurality of crystal planes 810-840, in which various embodiments of the invention may be applied.

In the crystal structure of a sapphire, as shown in FIG. 8, the sapphire crystal is a hexagonal system, wherein C-axis forms a central axis being vertical and normal to C-plane 820. Due to the symmetry of the sapphire crystal structure the A-plane has numerous A-axes in FIG. 8, for example axis a1 to a3 that are to be extended in three directions perpendicular to C-axis. Respectively, A-plane 810 is shown in FIG. 8. M-plane 830 is perpendicular to C-plane 820 and A-plane 810. R-plane 840 is oblique at a constant angle to C-axis.

No matter only four planes 810-840 is shown, the crystal cell may comprise other planes. Furthermore, due to crystal symmetry, there may be several identical planes for each major plane. For example, the unit cell 800 may comprise three A-planes 810, three R-planes 840, one C-plane 820 and three M-planes 830, for example.

The C-axis is typically angled approximately 57.6 degrees with respect to the R-axis. The R-axis is typically angled with respect to the M-axis by approximately 32.4 degrees.

The planes and axes of the sapphire can be analyzed for example with X-ray or electron diffraction and can be determined about the actual sapphire single crystal.

In an embodiment, measurements of the sapphire crystal have revealed that A-plane is generally the strongest plane regarding to mechanical stress. However, the integration of sapphire to an touch sensitive device of a portable apparatus may be taken even further by controlling anisotropy (sometimes referred to as minor planes) such that the sapphire is orientated within the touch sensitive device of the apparatus for maximum strength and hence reliability.

In an embodiment, the crystal planes and directions in hexagonal systems may be indexed using Miller indices, wherein crystallographically equivalent planes have indices which appear dissimilar. To overcome this Miller-Bravais indexing system may be used, where a fourth index is introduced to the three of the Miller system.

A plane is then specified using four indices (hkil), where h, k, i and l are integers. The third index is always the negative of the sum of the first two and can be determined from the Miller system.

A direction is specified as [uvtw] where u, v, t and w are integers. The values of u, v and t are adjusted so that their sum is zero. The direction index cannot be written down from the equivalent Miller index.

When looking at FIG. 8 and using the Miller-Bravais indices for defining the planes, following mapping could be used:
C-plane 820 corresponds to {0 0 0 1} of the Miller-Bravais indices;
R-plane 840 corresponds to {1̅ 0 1 2} of the Miller-Bravais indices;
A-plane 810 corresponds to {1 1 2̅ 0} of the Miller-Bravais indices; and
M-plane 830 corresponds to {1 0 1̅ 0} of the Miller-Bravais indices.

Referring to FIG. 4, A-plane of the sapphire cell 410 is shown. The length L in this embodiment is greater than the width W, as can be seen from FIG. 4. The sapphire crystallographic structure is configured so that a main plane of the sapphire cell 410 is set to be parallel to the surface plane of the touch sensitive device 420 and two minor planes are set to be parallel to the first and second axes (W and L).

In an embodiment, the touch sensitive device 420 of an apparatus has a length L in a direction of a first axis and a width W in a direction of a second axis, wherein the length L is greater than or equal to the width W. The touch sensitive device 420 is developed and comprising a sapphire crystallographic structure 410 having a plurality of crystal planes with corresponding normal axes represented as C-axis, A-axis and M-axis, for example. A first crystal plane axis is configured to be perpendicular to the first axis L and the second axis W. A second crystal plane axis is configured to be parallel to the first axis L and a third crystal plane axis is configured to be parallel to the second axis W.

In an embodiment, a sapphire crystallographic structure has a plurality of crystal planes, wherein three major planes maybe be represented by three orthogonal axis, wherein a first crystal plane axis is configured to be perpendicular to the second crystal plane axis and the third crystal plane axis is configured to be perpendicular to the first crystal plane axis and the second crystal plane axis.

The plurality of crystal planes comprise at least:
A-plane with A-axis configured to be a normal axis of the A-plane;
C-plane with C-axis configured to be a normal axis of the C-plane, the C-axis being perpendicular to the A-axis; and
M-plane with M-axis configured to be a normal axis of the M-plane, the M-axis being perpendicular to the A-axis and the C-axis.

In an embodiment, the plurality of crystal planes comprises:
A-plane with A-axis configured to be a normal axis of the A-plane, the A-axis being perpendicular to the C-axis and perpendicular to the M-axis; and
C-plane with C-axis configured to be a normal axis of the C-plane, the C-axis being perpendicular to the A-axis and perpendicular to the M-axis; and
M-plane with M-axis configured to be a normal axis of the M-plane, the M-axis being perpendicular to the A-axis and perpendicular to the C-axis.

In an embodiment, the first crystal plane axis is the A-axis perpendicular to the W-axis and the L-axis, the second crystal plane axis is the M-axis parallel to the L-axis and the third crystal plane axis is the C-axis parallel to the W-axis.

Configuring the sapphire crystal 410 planes so that A-plane is parallel to the surface plane of the touch sensitive device 420, such as flat display screen, provides improved strength for the touch sensitive device 420. Even further strength for the touch sensitive device is achieved by aligning the M-axis of the M-plane parallel to a longer side L of the touch sensitive device 420 and the C-axis of the C-plane parallel to a shorter side of the touch sensitive device 420.

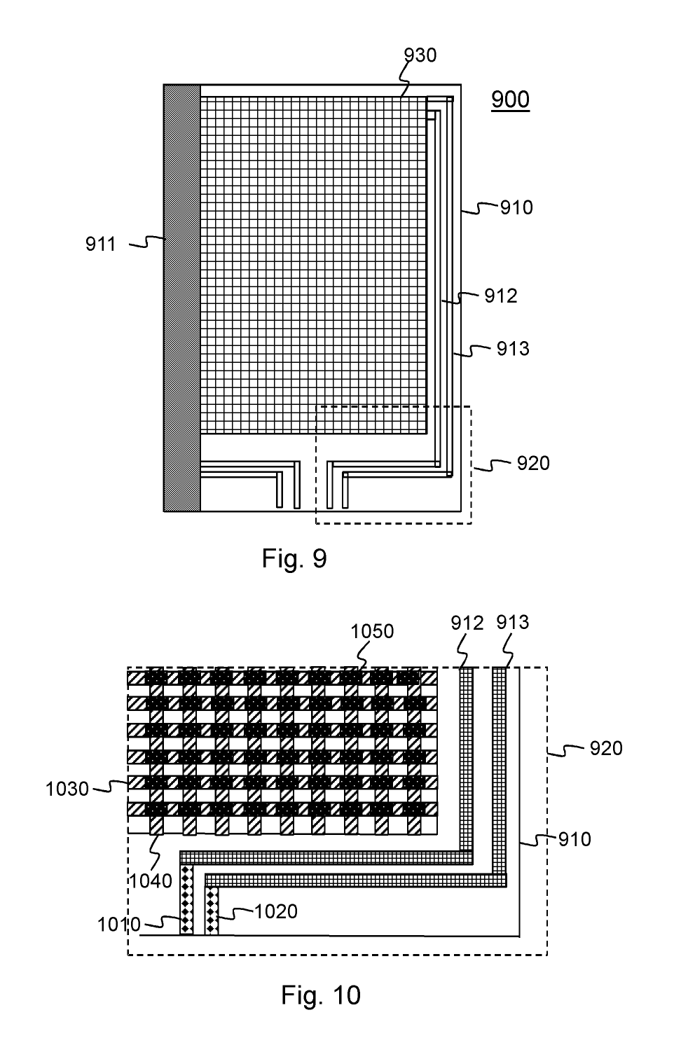

FIG. 9 shows an illustrative example on a touch sensitive device 900 in which various embodiments of the invention may be applied.

The touch sensitive device 900 is shown from above in light of FIG. 5 that illustrates the device from side view. The touch sensitive device 900 may comprise a layer of sapphire 910 having a first refractive index value and comprising a surface, wherein the surface is visible to a user.

In an embodiment, a polished sapphire 910 with a desired minor plane orientation may be printed with a non-transparent black mask layer 911. The black mask layer 911 may be provided on the edge areas of the touch sensitive device 900 to make metal tracks 912, 913 below invisible to the user. Choosing certain orientation of sapphire in terms of optical performance may enable avoiding additional ¼ wave plates required to circularly polarize light to maintain polarized sunglass compatibility.

A transparent conductive electrode layer 930 forms the X & Y layers. The sensor electrode pattern layer 930 might have both X and Y layers in the same plane and will be crossed over by indium tin oxide (ITO) jumpers or might have just one electrode in the sapphire surface, for example.

In an embodiment, both X & Y layers of the transparent conductive electrode layer 930 may be arranged on sapphire 910 surface. Then insulators may be applied either by spin coating or spray coating or another suitable process to form a uniform thickness and then photo-etched using a photo mask or ablated using laser or another similar process to form insulators for the indium tin oxide (ITO) jumpers.

Indium tin oxide (ITO) jumpers may be sputtered on top of these insulators and then etched using a suitable etching process like photolithography or laser ablation or similar and then connected to the corresponding sensor electrodes to complete the X & Y matrix that forms the basis of capacitive sensors.

In an embodiment, just one electrode (X or Y electrode) is arranged on sapphire 910 surface. Then insulators may not be used. Instead a separate material (film, glass or sapphire or clear ceramic) containing the other electrode will be optically bonded to the original sapphire substrate. The two electrodes will complete the X & Y matrix for capacitive sensing.

In an embodiment, the touch sensitive device 900 further comprises a metal track layer arranged in an edge area of the touch sensitive device for the first and the second transparent electrode pattern layer, configured to provide connection for the first and the second transparent electrode pattern layers. The metal track layer may comprise metal tracks 912, 913.

The metal tracks 912, 913 may need to be routed and then connected to the electrodes 930. The metal tracks 912, 913 are generally made of highly electrically conductive materials like copper or silver and may be sputtered and then etched similar to the indium tin oxide (ITO) pattern etching process. The black mask 911 that was applied in the first step aims to hide these metal tracks 912, 913, as shown in left edge of the device 900.

Another layer of black mask may then applied to hide the metal tracks to be visible and also insulate them from any conductive material to avoid short circuits.

In an embodiment, the touch sensitive device 900 further comprises at least one of the following:
a display of the mobile apparatus;
a cover part of the mobile apparatus; and
a touch sensitive screen of the mobile apparatus.

In an embodiment, a plurality of crystal planes are arranged to match a liquid-crystal display (LCD) top polarizer angle of the display and configured to circularly or elliptically polarize outgoing light.

FIG. 10 shows an illustrative example on a portion 920 of FIG. 9 of a touch sensitive device in which various embodiments of the invention may be applied.

The metal tracks 912, 913 may be routed in such a way that they come to a set of pads 1010, 1020 where a flexible printed circuit (FPC) is bonded using suitable processes like anisotropic conductive film (ACF). The printed circuit may carry the touch controller and other suitable components in it to make the touch sensor or the apparatus functional. It also carries suitable connectors to connect to the main engine to interact with the other parts of the mobile apparatus.

In an embodiment, a first transparent electrode pattern layer comprises rows 1030 and a second transparent electrode pattern layer comprises columns 1040. In FIG. 9 a transparent conductive electrode layer 930 may comprise both the first transparent electrode pattern layer comprising rows 1030 and the second transparent electrode pattern layer comprising columns 1040.

The transparent conductive electrode layer 930 of FIG. 9 forms the X layer comprising rows 1030 and Y layer comprising columns 1040 for the touch sensitive device 900. The sensor electrode pattern layer 930 of FIG. 9 might have both X and Y layers in the same plane and will be crossed over by indium tin oxide (ITO) jumpers 1050 or might have just one electrode in the sapphire surface, for example.

In an embodiment, both X & Y layers 1030, 1040 of the transparent conductive electrode layer 930 of FIG. 9 may be arranged on sapphire 910 surface. Then insulators may be applied either by spin coating or spray coating or another suitable process to form a uniform thickness and then photo-etched using a photo mask or ablated using laser or another similar process to form insulators for the ITO jumpers 1050.

ITO jumpers 1050 may be sputtered on top of these insulators and then etched using a suitable etching process like photolithography or laser ablation or similar and then connected to the corresponding sensor electrodes to complete the X & Y matrix 1030, 1040 that forms the basis of capacitive sensors.

In an embodiment, just one electrode 1030, 1040 (X or Y electrode) is arranged on sapphire 910 surface. Then insulators may not be used. Instead a separate material (film, glass or sapphire or clear ceramic) containing the other electrode 1030, 1040 will be optically bonded to the original sapphire substrate. The two electrodes 1030, 1040 will complete the X & Y matrix for capacitive sensing.

In an embodiment, the first transparent layer comprises both X and Y electrodes 1030, 1040 and the second transparent layer comprises jumpers 1050 when applied directly on to sapphire. In this case, the first layer has almost all of the X and Y lines 1030, 1040 and the second layer is used only to connect the missing connections to complete the matrix using the jumpers 1050.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A touch sensitive device for a mobile apparatus, the device having a length in a direction of a first axis and a width in a direction of a second axis, wherein the length is greater than or equal to the width, the device comprising:
a substrate comprising sapphire with a first refractive index value, the sapphire comprising sapphire crystallographic structure having a plurality of crystal planes, wherein a first crystal plane axis is configured to be perpendicular to the first and the second axis, wherein a first crystal plane axis is configured to be perpendicular to the first and the second axis, a second crystal plane axis is configured to be parallel to the and the touch sensitive device having a length in a direction of the M-axis and a width in a direction of the C-axis;
a first transparent electrode pattern layer with a second refractive index value configured to form a plurality of touch sensing elements parallel to the first axis;
a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and
an index matching layer arranged between the substrate and at least one of the transparent electrode pattern layers configured to match the first refractive index value and at least one of the second refractive index value and the third refractive index value; wherein at least one of the transparent electrode pattern layers being integral to the substrate.

2. The touch sensitive device of claim 1, wherein the sapphire comprising sapphire crystallographic structure having a crystal plane, the crystal plane comprising at least one of the first and the second transparent electrode pattern layers.

3. The touch sensitive device of claim 1, wherein the first and the second transparent electrode pattern layers being isolated using an isolating layer.

4. The touch sensitive device of claim 1, wherein a portion of the second transparent electrode pattern layer comprising at least one jumper configured to cross over a portion of the first transparent electrode pattern layer to form the second transparent electrode pattern layer.

5. The touch sensitive device of claim 4, wherein at least one of the transparent electrode pattern layers and the jumper comprising at least one of the following: indium tin oxide (ITO), graphene and silver nano wires.

6. The touch sensitive device of claim 1, wherein the second refractive index value and the third refractive index value are same.

7. The touch sensitive device of claim 1, wherein the second refractive index value and the third refractive index value are not same.

8. The touch sensitive device of claim 1, wherein the first transparent electrode pattern layer comprising indium tin oxide (ITO) and the second transparent electrode pattern layer comprising at least one of graphene and silver nano wires.

9. The touch sensitive device of claim 1, further comprising a metal track layer arranged in an edge area of the touch sensitive device for the first and the second transparent electrode pattern layer, configured to provide connection for the first and the second transparent electrode pattern layers.

10. The touch sensitive device of claim 9, further comprising a non-transparent mask layer arranged on the edge area of the touch sensitive device, wherein the non-transparent mask layer configured to hide the first and the second metal track.

11. The touch sensitive device of claim 1, wherein the metal track layer comprising a first and a second metal track.

12. The touch sensitive device of claim 1, wherein the touch sensitive device further comprises at least one of the following:
a display of the mobile apparatus;
a cover part of the mobile apparatus; and
a touch sensitive screen of the mobile apparatus.

13. (canceled)

14. The touch sensitive device of claim 1, wherein the plurality of crystal planes comprising:
A-plane with A-axis configured to be a normal axis of the A-plane;
C-plane with C-axis configured to be a normal axis of the C-plane, the C-axis being perpendicular to the A-axis; and
M-plane with M-axis configured to be a normal axis of the M-plane, the M-axis being perpendicular to the A-axis and the C-axis.

15. The touch sensitive device of claim 14, wherein the first crystal plane axis is the A-axis, the second crystal plane axis is the M-axis and the third crystal plane axis is the C-axis.

16. The touch sensitive device of claim 14, wherein a fourth crystal plane axis is configured to be perpendicular to the first crystal plane axis and inclined to the second and the third crystal plane axes.

17. The touch sensitive device of claim 14, wherein the touch sensitive device having a length in a direction of the M-axis and a width in a direction of the C-axis, wherein the length is greater than or equal to the width.

18. The touch sensitive device of claim 14, wherein the plurality of crystal planes being arranged to match a LCD top polarizer angle of the display and configured to circularly or elliptically polarize outgoing light.

19. A method for providing a touch sensitive device for a mobile apparatus, the device having a length in a direction of a first axis and a width in a direction of a second axis, wherein the length is greater than or equal to the width, the method comprising:
providing a substrate comprising sapphire with a first refractive index value, the sapphire comprising sapphire crystallographic structure having a plurality of crystal planes, wherein a first crystal plane axis is configured to be perpendicular to the first and the second axis, wherein a first crystal plane axis is configured to be perpendicular to the first and the second axis, a second crystal plane axis is configured to be parallel to the first axis and a third crystal plane axis is configured to be parallel to the second axis, and the touch sensitive device having a length in a direction of the M-axis and a width in a direction of the C-axis;
providing a first transparent electrode pattern layer with a second refractive index value configured to form a plurality of touch sensing elements parallel to the first axis;
providing a second transparent electrode pattern layer with a third refractive index value configured to form a plurality of touch sensing elements parallel to the second axis, wherein the first transparent electrode pattern layer and the second transparent electrode pattern layer configured to provide touch information using capacitive coupling; and
providing an index matching layer arranged between the substrate and at least one the transparent electrode pattern layers configured to match the first refractive index value and at least one of the second refractive index value and the third refractive index value; wherein at least one of the transparent electrode pattern layers being integral to the substrate.

20. A mobile apparatus comprising a touch sensitive device of claim 1.

21. The mobile apparatus of claim 20, wherein a higher strength axis of a sapphire element is aligned with a higher stress direction of the mobile apparatus.
